(19) United States
(12) Patent Application Publication
(10) Pub. No.: US 2014/0366114 A1
(43) Pub. Date: Dec. 11, 2014

(54) Login Method and Device, Terminal and Network Server

(71) Applicant: TENCENT TECHNOLOGY (SHENZHEN) COMPANY LIMITED, Shenzhen (CN)

(72) Inventors: Jiao Wang, Shenzhen (CN); Ling Liu, Shenzhen (CN); Liang Deng, Shenzhen (CN); Yibo Sun, Shenzhen (CN)

(21) Appl. No.: 14/464,933

(22) Filed: Aug. 21, 2014

Related U.S. Application Data
(63) Continuation of application No. PCT/CN2013/071377, filed on Feb. 5, 2013.

(30) Foreign Application Priority Data
Mar. 2, 2012 (CN) 201210054861.9

(51) Int. Cl. H04L 29/06

(52) U.S. Cl. CPC H04L 63/0838
USPC 726/7

(57) ABSTRACT

A login method and device, and a terminal and a network server are disclosed, which relate to communications technologies. In the method, acquire an account waiting for login and a first password, and judge whether the first password is the same as a local password bound with the pre-stored account. If the first password is the same as the local password bound with the pre-stored account, upload a second password corresponding to the pre-stored account to a network server for matching, and log in to the account once the second password is successfully matched. The present invention introduces a custom password (i.e., the first password), thus avoids the complexity to enter an actual login password (i.e., the second password) and the unsafety to remember the actual login password in a terminal, and enhances the convenience and safety for login and offers greater user experience.

The present application is a continuation of International Application No. PCT/CN2013/071377, filed on Feb. 5, 2013, which claims the benefit of Chinese Patent Application No. 2012100548619, entitled “Login Method and Device, Terminal and Network Server”, filed on Mar. 2, 2012 to the State Intellectual Property Office of China. The disclosure of each of the above applications is hereby incorporated in its entirety by reference.

### FIELD OF THE INVENTION

The present invention relates to communications technology, and particularly relates to a login method and device, terminal and network server.

### BACKGROUND OF THE INVENTION

With the evolvement of mobile internet devices, it is common for multiple people to share a large-screen device terminal. Meanwhile, to protect passwords of application programs in the terminal from stealing, a user has to increase the password length and complicate the password composition. The inconvenience for inputting may bring greater operational burden to usage of the terminal that requires privacy protection and may be met with several times a day by many people.

For example, in an existing technology, when the same terminal is used to log in to multiple accounts of multiple people, a user may select an existing account to log in when he/she plans to log in to an account. Two choices are provided below on privacy protection in an existing technology. One choice is to remember an actual login password, i.e., to remember an actual login password in a password input box corresponding to the account, and to log in to the account through the remembered password directly. This approach may easily cause privacy leak because other users may directly log in to the account in the same terminal once they completely remember the password. The other choice is to input a login password for login every time without remembering the password. However, the password is made increasingly complex with a composition of such as numbers, characters, and upper and lower case letters. As such, it is very troublesome to input the password every time, which brings inconvenience for the user, reduces the user experience, and influences the adoption intention of the user.

Consequently, an improved technical scheme is required to solve the above problems.

### SUMMARY OF THE INVENTION

In order to provide a convenient login method while guaranteeing the login safety and enhancing the user experience, embodiments of the present invention provide a login method and device, a terminal and a network server. The technical schemes are as follows.

A login method includes:

acquiring an account waiting for login and a first password;

judging whether the first password is the same as a local password bound with the pre-stored account; and

when the first password is the same as the local password bound with the pre-stored account, uploading a second password corresponding to the pre-stored account to a network server for matching, and logging in to the account when the second password is successfully matched.

Further, the local password bound with the pre-stored account includes: a custom password, or a combination of a custom password and a machine code.

More specifically, acquiring the first password includes:

receiving the first password input by a user; or

receiving a password input by a user, acquiring a machine code of a terminal, and combining the machine code with the input password as the first password; and

the process of judging whether the first password is the same as the local password bound with the pre-stored account includes:

judging whether the first password is the same as the custom password bound with the pre-stored account; or

judging whether the first password is the same as the combination of the custom password bound with the pre-stored account and the machine code.

A login device includes:

a first acquiring module, to acquire an account waiting for login and a first password;

a judging module, to judge whether the first password is the same as a local password bound with the pre-stored account; and

a login module, to upload a second password corresponding to the pre-stored account to a network server for matching, and log in to the account when the second password is successfully matched, when it is determined by the judging module that the first password is the same as the local password bound with the pre-stored account.

Further, the local password bound with the pre-stored account includes: a custom password, or a combination of a custom password and a machine code.

More specifically, the acquiring module is to receive the first password input by the user; or, the acquiring module is to receive an input password of the user, acquire a machine code of a terminal, and combine the input password with the machine code as the first password; and

the first judging module is to judge whether the first password is the same as the custom password bound with the pre-stored account; or, the first judging module is to judge whether the first password is the same as the combination of the custom password bound with the pre-stored account and the machine code.

A terminal includes: the login device as described above.

A login method includes:

receiving an account waiting for login, a first password, and a second password corresponding to the account sent from a terminal;

judging whether the first password is the same as at least one set of local passwords bound with the pre-stored account; and

when the first password is the same as any set of the local passwords bound with the pre-stored account, matching the second password received with a login password corresponding to the account, and allowing the terminal to log in to the account when the two passwords are successfully matched.

Further, the at least one set of the local passwords bound with the pre-stored account includes: at least one custom password, or at least one set of combinations of custom passwords and machine codes.

Further, the first password is sent by the terminal; and

judging whether the first password is the same as the at least one set of the local passwords bound with the pre-stored account includes:

receiving the first password sent by the terminal, and judging whether the first password is the same as the at least one custom password bound with the pre-stored account; or

receiving an input password and a machine code of the terminal sent from the terminal, combining the input password and the machine code of the terminal to form the first password, and judging whether the first password is the same as the at least one set of combinations of the custom passwords bound with the pre-stored account and the machine codes.

A network server includes:

a receiving module, to receive an account waiting for login, a first password and a second password bound with the account sent by a terminal;

a second judging module, to judge whether the first password is the same as at least one set of local passwords bound with the pre-stored account; and

a second login module, to match the second password received with a login password corresponding to the account, and allow the terminal to log in to the account when the two passwords are successfully matched, when the second judging module judges that the first password is the same as any set of the local passwords bound with the pre-stored account.

Further, the at least one set of the local passwords bound with the pre-stored account includes: at least one custom password, or at least one set of combinations of custom passwords and machine codes; and

the first password includes: an input password from a user, or a combination of an input password from a user and a machine code of the terminal.

Further, the second judging module is to judge whether the first password is the same as the at least one custom password bound with the pre-stored account; or

the second judging module is to judge whether the first password is the same as the at least one set of the combinations of the custom passwords bound with the pre-stored account and the machine codes.

A login system includes: the terminal as described above, and the network server as described above.

The technical schemes provided in the embodiments of the present invention can be of benefits as follows.

A local password is preset, which is a custom password defined by a user, and bound with an account. When a first password is the same as the local password bound with the account, it is permitted to log in to the account. Using the local password matching for login makes the login more convenient and avoids the unsafety of using a second password (i.e., an actual login password of the account). Herein, the local password can be an input password from a user, or a combination of an input password and a machine code of a terminal. In this way, an illegal user is prevented from logging in to the account in other terminals even though he has acquired the local password, and the login may become safer. Besides, the local password can be stored in a network server where the password is authenticated and matched, thereby further ensuring the information safety.

### BRIEF DESCRIPTION OF DRAWINGS

For a better understanding of the technical schemes in embodiments of the present invention, brief illustrations will be made below for the figures necessary in the embodiments. Obviously, following figures in the description are just some embodiments of the present invention, and those skilled in the art can obtain other figures through these figures without any creative labor.

FIG. 1 is a diagram illustrating an execution environment of a login method provided in an embodiment of the present invention;

FIG. 2 is a flow diagram illustrating a login method provided in Embodiment 1 of the present invention;

FIG. 3 is a flow diagram illustrating a login method provided in Embodiment 2 of the present invention;

FIG. 4 is a diagram illustrating an interface switching from a second password login to a first password login provided in Embodiment 2 of the present invention;

FIG. 5 is a flow diagram illustrating a login method provided in Embodiment 3 of the present invention;

FIG. 6 is a structural diagram illustrating a login device provided in Embodiment 4 of the present invention;

FIG. 7 is a flow diagram illustrating a login method provided in Embodiment 5 of the present invention;

FIG. 8 is a flow diagram illustrating a login method provided in Embodiment 6 of the present invention;

FIG. 9 is a flow diagram illustrating a login method provided in Embodiment 7 of the present invention;

FIG. 10 is a structural diagram illustrating a network server provided in Embodiment 8 of the present invention.

### DETAILED DESCRIPTION OF THE INVENTION

To show the purpose, technical scheme and benefits of the present invention more clearly, detailed description of the present invention is further provided as follows, and “multiple” in the description means at least one.

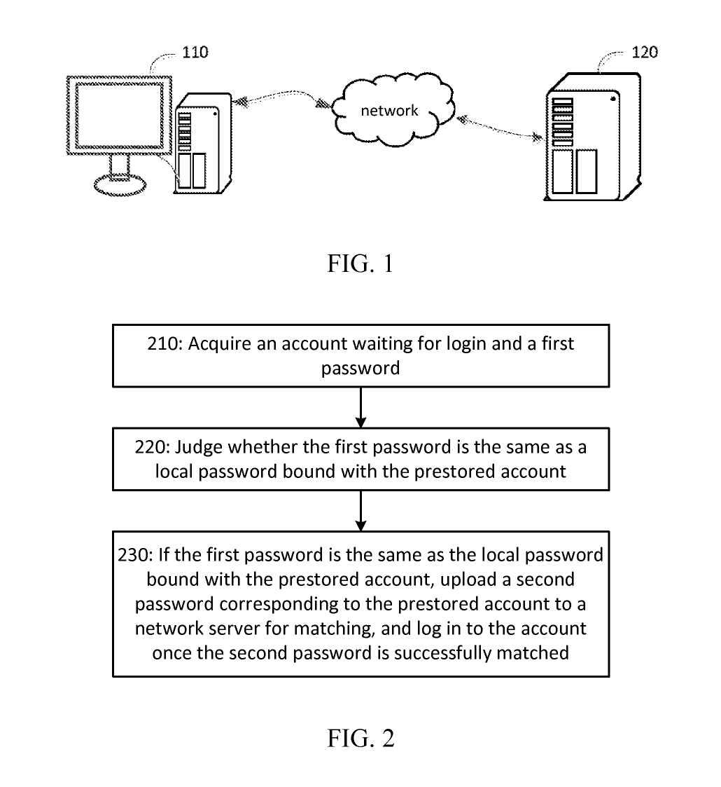

FIG. 1 is a flow diagram illustrating an execution environment of a login method provided in an embodiment of the present invention. The execution environment may include a terminal 110 and a network server 120.

The terminal 110 may be a terminal device such as a mobile phone, a computer, etc., where programs are installed for logging in. An account of the program corresponds to a second password. Once a second password corresponding to an account is input, a login may be implemented by a program for the account.

The network server 120 is used for storing accounts of the programs and a login password corresponding to every account.

Herein, the terminal 110 and the network server 120 transmit related data to each other via a network, where the network may include wired or wireless communication channels.

### Embodiment 1

FIG. 2 is a flow diagram of a login method provided in Embodiment 1 of the present invention. The login method can be applied in a terminal 110 shown in FIG. 1, which includes:

At Step 210, acquire an account waiting for login and a first password.

The first password can be an input password for the account waiting for login, or a combination of an input password for the account waiting for login and a machine code of a terminal to receive the input password (i.e., the terminal 110).

Herein, the machine code is used for uniquely identifying a terminal, and the machine code of the terminal 110 is a unique identification code for the terminal 110.

At Step 220, judge whether the first password is the same as a local password bound with the pre-stored account.

In this embodiment, the local password may be a custom password stored in the terminal and bound with the account. The custom password may be a password preset by the user for the account waiting for login, and generally be easy to remember or input. The process of judging whether the first password is the same as the local password bound with the pre-stored account may include: judging whether the first password is the same as the custom password bound with the pre-stored account.

The local password may also be a combination of a custom password stored in the terminal and bound with the account and a machine code. That is, besides the custom password set for the account waiting for login and easy for the user to remember and input, the local password may also include the machine code of the corresponding terminal while setting the custom password. The process of judging whether the first password is the same as the local password bound with the pre-stored account may include: judging whether the first password is the same as the combination of the custom password bound with the pre-stored account and the machine code.

To avoid the complexity of the custom password, the custom password can be set relatively simple and generally includes a composition of symbols such as letters, numbers, or punctuation. For example, a custom password can be set as 123 or abc. Users can also set a custom password according to their own habits of memorizing.

At Step 230, if the first password is the same as the local password bound with the pre-stored account, upload a second password corresponding to the pre-stored account to a network server for matching, and log in to the account once the second password is successfully matched.

The second password is an actual login password corresponding to the pre-stored account, that is, an actual login password corresponding to the account for logging in to the network server. Generally, the second password will be set when the account is applied for.

The network server 120 may generally include the account and the corresponding login password. While receiving the account and the second password bound with it, the network server 120 may search for the same account, inquire about the corresponding login password within the network server 120 based on the account, and compare the second password received with the login password got via the inquiry. If they are the same, it means that the login password is successfully matched by the network server, and then it is allowable to log in to the account.

In a word, the login method provided in Embodiment 1 of the present invention makes login easier and safer, and offers greater user experience.

### Embodiment 2

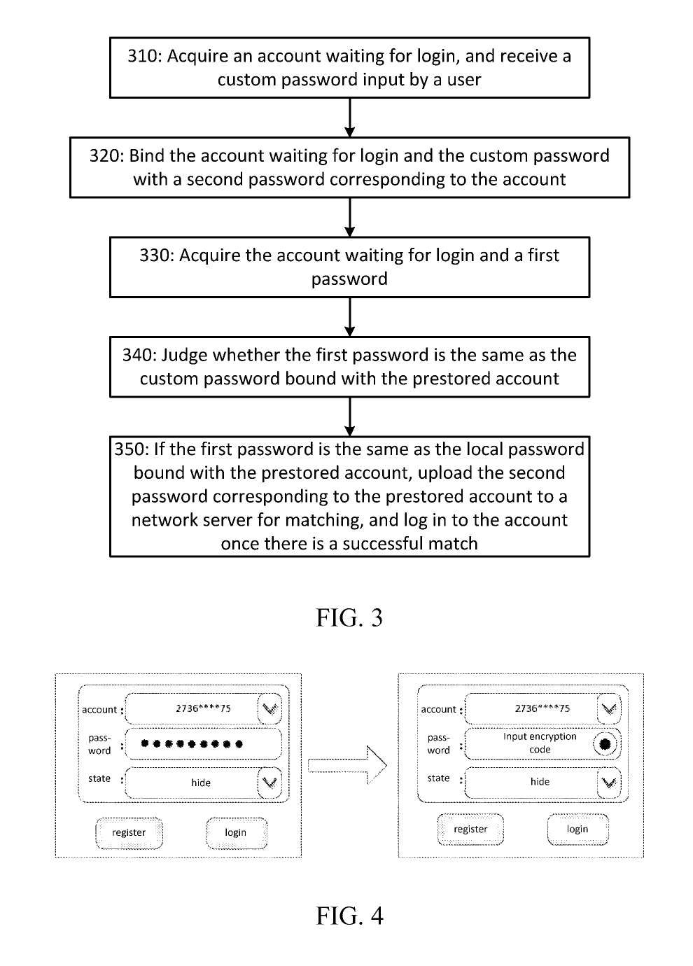

FIG. 3 is a flow diagram illustrating a login method provided in Embodiment 2 of the present invention, and the method can be applied in a terminal 110 shown in FIG. 1. The login method includes:

At Step 310, acquire an account waiting for login, and receive a custom password input by a user.

The custom password is a kind of password preset by a user for the account waiting for login. Generally, a relatively simple custom password may be set to avoid the complexity and make it easy for the user to remember and input. The custom password may be generally combined by symbols such as letters, numbers, punctuation, etc. For example, the custom password may be set as 123 or abc. In practice, only one custom password is generally set for the same account in a fixed terminal 110. That is, there is only one custom password corresponding to one account in the same terminal 110.

In practice, switching to a control to input the custom password may be achieved by a switching button, and a desired custom password can be input on the control. The specific implementation may refer to FIG. 4, wherein the left diagram is a login surface for inputting a second password, and through the switching button or making other operations, the mode of inputting the second password may switch to the mode of inputting the custom password as shown in the right diagram.

At Step 320, bind the account waiting for login and the custom password with a second password corresponding to the account.

The network server allows a login to a corresponding account when the second password is right. Generally, the second password can also be generated by combining symbols such as letters, numbers and punctuation, and its composition and length is more complex than the custom password.

After the custom password is input, a backend of the terminal 110 receives the custom password and takes it as a local password of the account waiting for login, binds the custom password with a corresponding account for which the custom password is set and a second password corresponding to the account, and stores them. That is, the custom password, the account waiting for login, and the second password corresponding to the account are bound and stored in the terminal backend.

While setting the custom password for the account waiting for login, the second password of the account waiting for login should also be input and the custom password will take effect only when the login can be made via the second password. In a preferred embodiment, the second password has generally been used and is remembered in the terminal 110. Then, the custom password may be bound with the second password while setting the custom password. Specifically, the terminal backend can store the account, the custom password and the second password bound together into a database.

Note that once the custom password has been set, the mode of logging in to an account by remembering a second password is canceled. Though this custom password has been stored in the terminal backend, the account login can only be achieved through the custom password or inputting the second password.

At Step 330, acquire the account waiting for login and a first password.

Acquire a latest input password corresponding to the current account waiting for login, and define the input password as the first password.

At Step 340, judge whether the first password is the same as the custom password bound with the pre-stored account.

After receiving the first password input for the current account waiting for login, inquire about the custom password bound with the account (i.e., the local password). Inputting every first password is based on a selected account waiting for login, and every input password is uniquely corresponding to one of the accounts waiting for login. So after receiving the first password, inquire about the corresponding custom password in the terminal backend on the basis of the corresponding account.

At Step 350, if the first password is the same as the local password bound with the pre-stored account, upload the second password corresponding to the pre-stored account to a network server for matching, and log in to the account once there is a successful match.

When the custom password corresponding to the account (i.e., the local password) is inquired about, compare the input first password with the custom password, and upload the account and the second password bound with the account to a network server 120 if the two passwords are the same.

Correspondingly, the network server 120 may include a database to store accounts and login passwords corresponding to the accounts. Based on an account uploaded by the terminal 110, the network server 120 can inquire about the login password corresponding to the account within the server, and match the second password bound with the account uploaded by the terminal 110 with the login password inquired about.

When the match is successful, the network server 120 feeds back a message of successful matching to the terminal 110, and once receiving the message the terminal 110 logs in to the account.

In conclusion, in the login method provided in Embodiment 2 of the present invention, a custom password for an account is preset and a user can log in by inputting a first password the same as the custom password. It avoids the complication of inputting a second password and the unsafety of remembering the second password in a login terminal, makes the login of an account easier and safer, and offers greater user experience.

### Embodiment 3

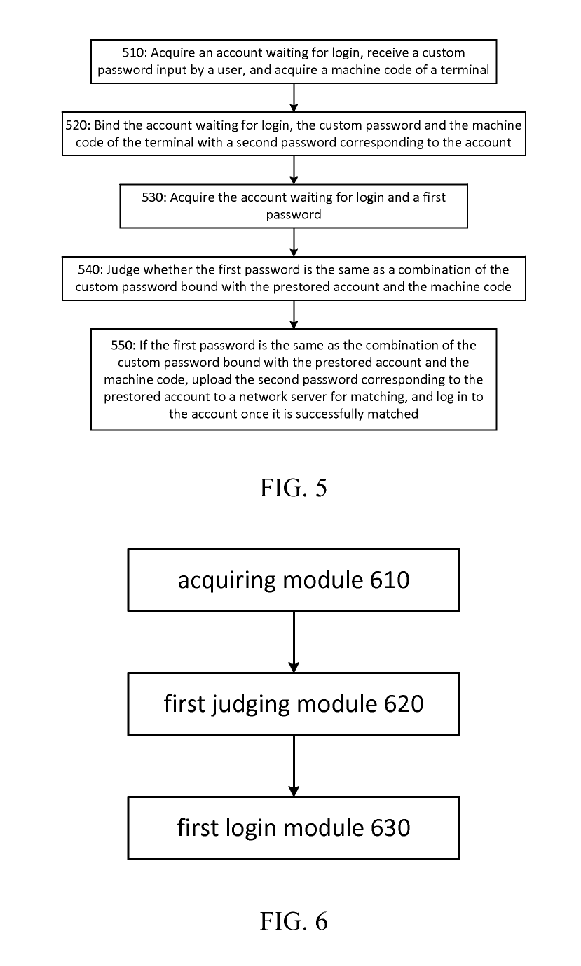

FIG. 5 is a flow diagram illustrating a login method provided in Embodiment 3 of the present invention. The method can be applied in a terminal 110 shown in FIG. 1, and the method includes:

At Step 510, acquire an account waiting for login, receive a custom password input by a user, and acquire a machine code of the terminal.

The custom password is a kind of password preset by a user for the account waiting for login. Generally, the custom password is set simple to avoid the complexity and be easy for the user to remember and input. The custom password may be generally combined by symbols such as letters, numbers, punctuation, etc. In an example, the custom password may be set as 123 or abc. In practice, only one custom password is generally set for the same account in a fixed terminal. That is, there is only one custom password corresponding to one account in the same terminal 110.

In practice, switching to a control to enter the custom password may be achieved by a switching button, and a desired custom password can be input via the control. Specifically, as shown in FIG. 4, a login surface for inputting a second password is presented in the left diagram, and through a switching button or taking other operations, the mode of inputting the second password may switch to the mode of inputting the custom password shown in the right diagram.

The machine code is an initial machine code corresponding to the terminal 110 when setting the custom password. A machine code is used to uniquely identify a terminal, and the machine code of the terminal 110 is the only identification code of the terminal 110. Therefore, all machine codes acquired from the same terminal are the same.

At Step 520, bind the account waiting for login, the custom password and the machine code of the terminal with a second password corresponding to the account.

After inputting the custom password and acquiring the corresponding machine code, the backend of the terminal 110 receives the custom password and takes it as a local password, meanwhile acquires a current machine code of the terminal as the machine code of the terminal, binds the custom password, the machine code of the terminal and the account waiting for login while setting the custom password with a second password corresponding to the account, and stores them. That is, bind the custom password, the machine code and the corresponding account with the second password corresponding to the account, and store them in the terminal backend.

Herein, the second password is an actual login password desired by the user for logging in to the account via the terminal, i.e., an actual login password corresponding to a login of the account to a network server 120. Generally, the second password may be set when the user applies for an account. Usually, the second password is set a bit more complex to ensure the account safety. For example, the second password may also be combined by symbols such as letters, numbers, and punctuation, while its composition and length is more complex than the custom password.

While setting the custom password for the account waiting for login, the second password of the account waiting for login should also be input, and the custom password will take effect when the login has been made via the second password. In a preferable embodiment, the second password is generally used and remembered in the terminal, so it can be bound with the custom password while setting the custom password. Specifically, the terminal backend can store every set of accounts, custom passwords, machine codes and second passwords through a database.

Note that once the custom password has been set, the mode of logging in to an account by remembering a second password is canceled. Though this custom password has been stored in the terminal backend, the login of the account can only be achieved through the custom password or inputting the second password.

At Step 530, acquire the account waiting for login and a first password.

Acquire an input password corresponding to the account waiting for login, acquire the current machine code of the terminal, and combine the input password and the current machine code of the terminal as the first password.

At Step 540, judge whether the first password is the same as a combination of the custom password bound with the pre-stored account and the machine code.

Inquire about the custom password bound with the account in the terminal backend according to the input password. Every input password is input on the basis of a selected account waiting for login, and the input password uniquely corresponds to the selected account waiting for login. After receiving the input password, inquire about the corresponding custom password in the terminal backend based on the account waiting for login corresponding to the input password.

Inquire about the initial machine code corresponding to the custom password based on the inquired custom password.

Compare whether the input password in the first password and the current machine code are the same as the custom password bound with the account and the initial machine code, respectively. For example, when an illegal user copies a system in an original terminal A to another terminal B, the backend of terminal B may also acquire the account, the second password, the custom password and the initial machine code (i.e., the machine code of terminal A) stored in the backend of terminal A. However, the illegal user cannot see the second password and the custom password in a form of words. Therefore, when the illegal user enters a correct input password which is the same as the custom password, since the machine code of terminal B is still different from the initial machine code, the custom password bound with the account and the initial machine code cannot be inquired about according to the input password and the account corresponding to the current machine code.

At Step 550, if the first password is the same as the combination of the custom password bound with the pre-stored account and the machine code, upload the second password corresponding to the pre-stored account to a network server for matching, and log in to the account once it is successfully matched.

If the input password in the first password is the same as the custom password meanwhile the machine code in the first password is the same as the machine code while setting the custom password, it means that a correct input password for the account has been input in the same terminal where the user initially sets the custom password. Therefore, the account and the second password bound with the account may be uploaded to the network server 120.

The network server 120 may include accounts and login passwords corresponding to the accounts. After receiving the account and the second password, the network server 120 inquires about the login password corresponding to the account within the server based on the account, and matches the inquired login password with the second password received.

Once the network server successfully matches the inquired login password to the second password, it informs the terminal 110 that sends the account and the second password to log in to the account.

In summary, the login method provided in Embodiment 3 of the present invention may set a custom password easily used for an account. Also, a machine code of the terminal is introduced. Therefore, the login to a corresponding account may be achieved only if a correct custom password has been input in the same terminal. It is impossible to log in to the corresponding account even though the correct custom password has been input in another terminal. In this way, the account login may be easier and safer, and the user experience may be enhanced.

### Embodiment 4

FIG. 6 is a structural diagram illustrating a login device provided in Embodiment 4 of the present invention, and the device is included in a terminal 110 shown in FIG. 1. The device includes an acquiring module 610, a first judging module 620, and a first login module 630.

The acquiring module 610 is used for acquiring an account waiting for login and a first password.

The first judging module 620 is used for judging whether the first password is the same as a local password bound with the pre-stored account, wherein the local password bound with the pre-stored account includes a custom password, or a combination of a custom password and a machine code.

The login module 630 is used for uploading a second password corresponding to the pre-stored account to a network server to match, and logging in to the account once there is a successful match, if the first judging module 620 judges that the first password is the same as the local password bound with the pre-stored account.

Preferably, if the local password bound with the pre-stored account is a custom password, the acquiring module 610 is used for acquiring an account waiting for login and receiving a first password input by a user. The first judging module 620 is used for judging whether the first password is the same as the custom password bound with the pre-stored account.

More preferably, if the local password bound with the pre-stored account is a combination of a custom password and a machine code, the acquiring module 610 is used for acquiring an account waiting for login, receiving a first password input by a user, acquiring a current machine code of the terminal, and combining the input password and the machine code as the first password. The first judging module 620 is used for judging whether the first password is the same as the combination of the custom password bound with the pre-stored account and the machine code.

To be sure, the login device divided into the function modules provided in the above embodiment is illustrated as an example. In practice, the above functions can be implemented by different function modules, if necessary. That is, the inner structure of the network server can be divided into function modules different from those illustrated in the above embodiment to complete some or all of the above functions. Besides, the login device in the above embodiment has a same concept as embodiments of the login method, and the concrete realization process is as shown in the method embodiments which may not be listed here.

In short, with the login device provided in Embodiment 4 of the present invention, a custom password easily be entered is set for an account, and a machine code of the terminal is also introduced. In this way, a login to the corresponding account may be realized only when a correct custom password has been input in the same terminal, and the corresponding account cannot be logged in to via another terminal even though the correct custom password has been input. This makes the account login easier and safer, and offers greater user experience.

### Embodiment 5

FIG. 7 is a flow diagram illustrating a login method provided in Embodiment 5 of the present invention, and the method is applied in a network server 120 shown in FIG. 1. The method includes:

At Step 710, receive an account waiting for login, a first password and a second password corresponding to the account sent from a terminal.

The first password may be an input password for the account waiting for login sent by the current terminal 110, or a combination of the input password for the account waiting for login and a machine code of the current terminal 110 sent by the current terminal 110.

Herein, the machine code is a machine code of the terminal 110 used for inputting the password and can be used to uniquely identify a terminal, so the machine code of the terminal 110 is the unique identification code for the terminal 110. All machine codes acquired from the same terminal are the same.

At Step 720, judge whether the first password is the same as at least one set of local passwords bound with the pre-stored account.

Herein, if the first password is an input password for the account waiting for login sent by the terminal 110, the at least one set of the local passwords bound with the pre-stored account may include at least one custom password.

If the first password is the combination of the input password for the account waiting for login and a machine code of the current terminal 110 sent by the terminal 110, the at least one set of the local passwords bound with the pre-stored account may include at least one combination of custom passwords and machine codes.

At Step 730, if the first password is the same as any set of the local passwords bound with the pre-stored account, match the second password received up to a login password corresponding to the account, and allow the terminal to log in to the account once they are successfully matched.

The second password is an actual login password of the account waiting for login in the terminal 110, i.e., a corresponding actual login password when using the account to log in to a network server. Generally, the second password may be set when a user applies the account waiting for login.

The login password in the network server 120 is a password stored in the network server 120 and set for login of an account. Before the login password in the network server 120 is changed, the login password is the same as the second password corresponding to the account. In practice, when the network server 120 determines that the second password received is the same as the corresponding login password, the network server may control the terminal 110 to log in to the corresponding account.

In light of the above, if an illegal user has acquired the first password and the second password, a legal user can interact with the network server 120 through an authentication message to change the login password corresponding to the account and protect the account from login by the illegal user. Therefore, even when the illegal user has acquired the first password and the second password, the second password is not the same as the login password at this time, i.e., they may not be successfully matched, and the information leakage of the account may be avoided accordingly.

In conclusion, in the login method provided in Embodiment 5 of the present invention, when an account and a corresponding first password are both correct, compare a login password in a network server and a second password, and allow the login if the second password is the same as the login password in the network server. If they are not the same, it means that the login password has been changed by a legal user, and an illegal user cannot use the original first password and second password to log in to the corresponding account. Therefore, it makes the account login safer, and offers greater user experience.

### Embodiment 6

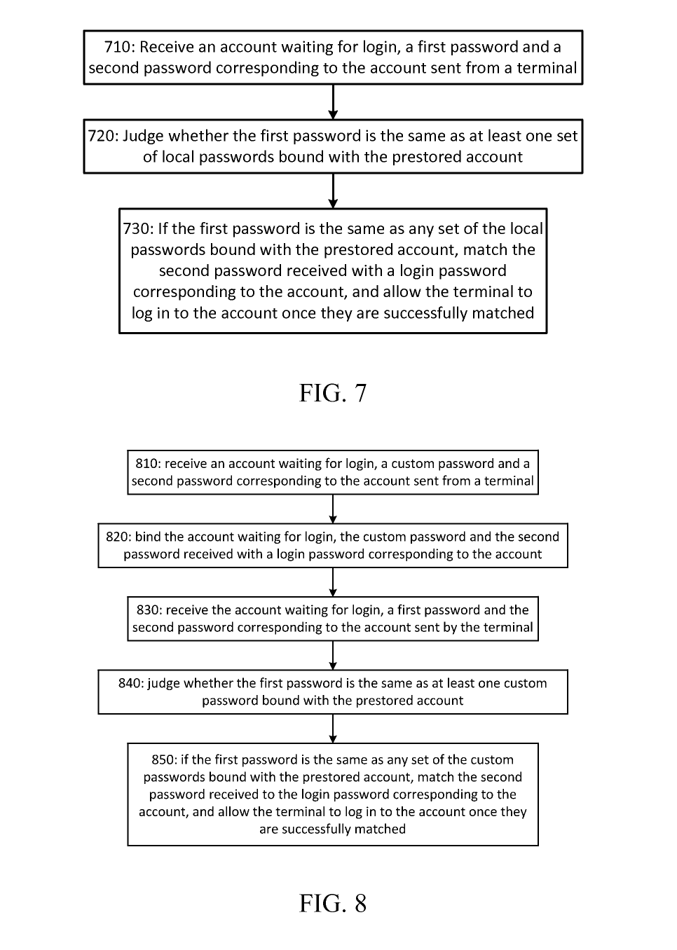

FIG. 8 is a flow diagram illustrating a login method provided in Embodiment 6 of the present invention, and the method is applied in a network server 120 shown in FIG. 1. The method includes:

At Step 810, receive an account waiting for login, a custom password and a second password corresponding to the account sent from a terminal.

The custom password is a kind of password initially set by a terminal 110 for the account waiting for login, and may be set according to a setter's requirements. Generally, the custom password is set simply to avoid the complexity. The custom password may generally be formed by symbols such as letters, numbers, or punctuation, etc. In an example, the custom password may be set as 123 or abc. Certainly, the setter can even set the custom password according to his memory habits. In practice, only one custom password is generally set for the same account in a fixed terminal 110. That is, there is only one custom password corresponding to one account in the same terminal 110.

The second password is an actual login password set for the account login, and is usually set when a user applies an account. Generally, the more complex the second password is made, the safer the account is. The second password may also be combined by symbols such as letters, numbers, or punctuation, etc., and its composition and length is generally more complex than the custom password.

In other words, after setting a custom password for an account waiting for login, the terminal 110 sends the account waiting for login, the corresponding custom password and the second password corresponding to the account to the network server 120.

When different terminals 110 repeatedly set custom passwords for the same account, they all send the account, the custom passwords and the second passwords corresponding to the account to the network server 120. In light of this, for the same account, there may be several sets of data in the network server 120 combined by the account waiting for login, the custom passwords and the second passwords corresponding to the account.

At Step 820, bind the account waiting for login, the custom password and the second password received with a login password corresponding to the account.

The login password is a login password for the account waiting for login stored in the network server 120. Generally, before the login password is changed, the login password is the same as the second password. In practice, when the network server 120 judges that the second password received is the same as the corresponding login password, the network server 120 may control the terminal 110 to log in to the corresponding account.

At Step 830, receive the account waiting for login, a first password and the second password corresponding to the account sent by the terminal.

The first password is an input password for the account waiting for login sent by the terminal 110.

When the terminal inputs the first password for the account waiting for login, it will send the account waiting for login, the first password and the second password corresponding to the account to the network server 120.

At Step 840, judge whether the first password is the same as at least one custom password bound with the pre-stored account.

Different terminals may set custom passwords for the same account, and the account, a custom password and a second password corresponding to the account will be sent to the network server 120 while the custom password is set for the account. Therefore, there may be at least one custom password for the same account in the network server 120, and all the second passwords corresponding to the account are the same.

At Step 850, if the first password is the same as any set of the custom passwords bound with the pre-stored account, match the second password received up to the login password corresponding to the account, and allow the terminal to log in to the account once they are successfully matched.

In practice, the user may set the same or different custom passwords for the same account in several terminals 110, and there may be several sets of different custom passwords for the same account stored in the network server 120. Therefore, the second password received may be matched up to the login password bound with the account when the first password is the same as one of the custom passwords.

For example, if an illegal user has acquired the custom password and the second password, a legal user can interact with the network server 120 through authentication messages to change the login password corresponding to the account, and protect the account from login by the illegal user. Therefore, even though the illegal user has acquired the custom password and the second password, at this time the second password is not the same as the login password and they are not successfully matched, which may avoid the leak of account information.

While the two passwords are matched successfully, feedback a login message to the terminal, to enable the terminal to log in to the account.

To sum up, in the login method provided in Embodiment 6 of the present invention, when an account and its first password are both correct, compare a second password with a login password in a network server, and allow the login if the second password is the same as the login password in the network server. If they are not the same, it means that the login password has been changed by the legal user, and the illegal user cannot use the original first password and second password to log in to the corresponding account. Therefore, it makes the account login safer, and offers greater user experience.

### Embodiment 7

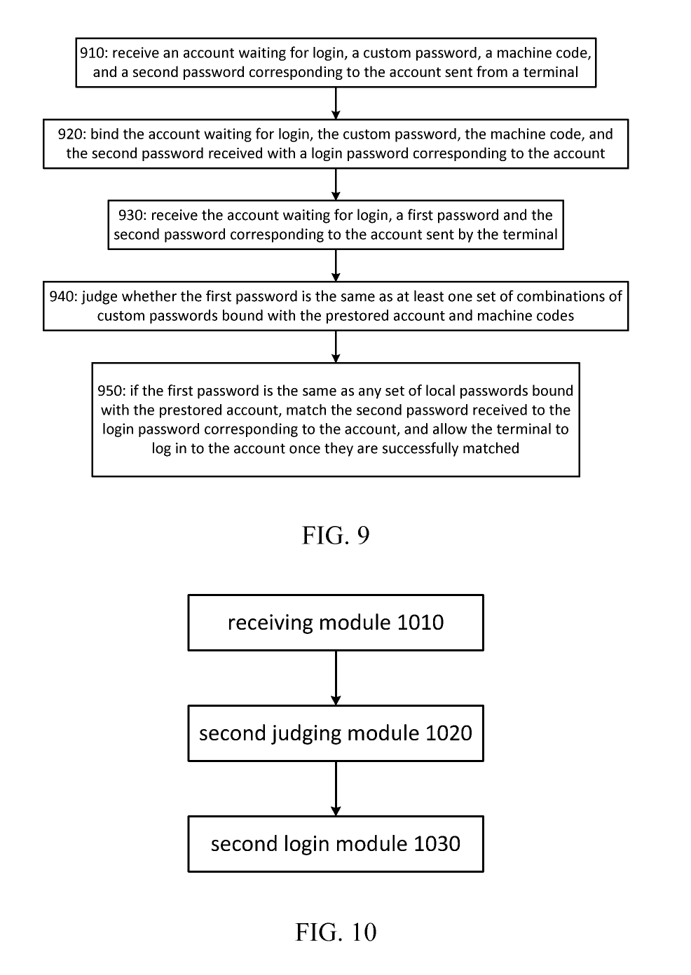

If a terminal 110 of a legal user has been stolen, an illegal user may acquire a second password or a first password of the legal user's account, and log in to the account through inputting the second password or the first password. To avoid the above problem, another login method is also provided in an embodiment of the present invention, and a detailed process is shown in FIG. 9.

FIG. 9 is a flow diagram illustrating a login method provided in Embodiment 7 of the present invention, and the method is applied in a network server 120 shown in FIG. 1. The method includes:

At Step 910, receive an account waiting for login, a custom password, a machine code, and a second password corresponding to the account sent from a terminal.

The custom password is a kind of password initially set by a terminal 110 for the account waiting for login, and may be set by a setter for himself. The custom password is generally set simply to avoid the complexity. The custom password may generally be combined by symbols such as letters, numbers, or punctuation, etc. For example, the custom password may be set as 123 or abc. Certainly, the setter can even set the custom password according to his habit of memorizing. In practice, only one custom password is generally set for the same account in a fixed terminal 110. That is, there is only one custom password corresponding to one account in the same terminal 110.

The machine code is used for uniquely identifying a terminal, and the machine code of the terminal 110 may uniquely identify the terminal 110.

The second password is an actual login password set for the account login, and is usually set when a user applies for an account. Generally, the more complex the second password is configured, the safer the account is. The second password may also be combined by symbols such as letters, numbers or punctuation, etc., and its composition and length generally is more complex than the custom password.

In other words, after setting a custom password for an account waiting for login, the terminal 110 sends the account waiting for login, the corresponding custom password, a machine code of the terminal 110, and a second password corresponding to the account to the network server 120. When different terminals repeatedly set custom passwords for the same account, they may send the account, the custom passwords, the machine codes corresponding to the terminals and the second passwords corresponding to the account to the network server 120.

In light of the above, for the same account, there may be several sets of data combined by the account waiting for login, the custom passwords, the machine codes and the second passwords corresponding to the account stored in the network server 120. Herein, the machine codes in several sets of data are different.

At Step 920, bind the account waiting for login, the custom password, the machine code, and the second password with a login password corresponding to the account.

The login password is a login password for the account waiting for login stored in the network server 120. Generally, the second password may be the same as the login password. In practice, when the network server 120 judges that the second password received is the same as the corresponding login password, it may control the terminal 110 to log in to the corresponding account.

At Step 930, receive the account waiting for login, a first password and the second password corresponding to the account sent by the terminal.

The first password is a combination of the input password for the account waiting for login and the corresponding machine code sent by the terminal 110.

When the terminal inputs the first password for the account waiting for login, it may send the account waiting for login, the first password and the second password corresponding to the account to the network server 120.

At Step 940, judge whether the first password is the same as at least one combination of the custom password bound with the pre-stored account and the machine code.

Different terminals may set custom passwords for the same account, and the account, a custom password, a machine code and a second password corresponding to the account will be sent to the network server 120 while the custom password is set for the account. Therefore, there may be at least one combination of custom passwords and machine codes for the same account in the network server 120, though all the second passwords corresponding to the account are the same.

Therefore, once the custom password and machine code corresponding to the received first password for the account waiting for login are correct, the first password may be the same as a combination of the custom password bound with the pre-stored account and the machine code. If the custom password and machine code corresponding to the received first password for the account waiting for login are wrong, the first password may be different from any combination of the custom password bound with the pre-stored account and the machine code.

At Step 950, if the first password is the same as any set of local passwords bound with the account, match the second password received up to the login password corresponding to the account, and allow the terminal to log in to the account once they are successfully matched.

In practice, the user may set the same or different custom passwords for the same account in several terminals 110, and there may be several different combinations of custom passwords and machine codes for the same account stored in the network server 120. Therefore, compare the second password received with the login password bound with the account when the first password is the same as a combination of the custom password and the machine code.

For example, if an illegal user has stolen a terminal of a legal user and acquired the custom password or the second password, the legal user can interact with the network server 120 through an authentication message to change the login password corresponding to the account. Therefore, even though the illegal user has acquired the custom password, the corresponding machine code and the second password, since the second password is not the same as the login password, i.e., they are not successfully matched, the leak of account information may be avoided.

After a successful match, the network server 120 feeds back a login message to the terminal, so the terminal can log in to the account.

In conclusion, in the login method provided in Embodiment 7 of the present invention, when an account and its first password are both correct, compare a second password with a login password in a network server, and allow the login if the second password is the same as the login password in the network server. Otherwise, it means that the login password has been changed by the legal user, and the illegal user cannot use the original first password and second password to log in to the corresponding account. Therefore, it makes the account login safer and offers greater user experience.

### Embodiment 8

FIG. 10 is a structural diagram illustrating a network server provided in Embodiment 8 of the present invention, and the network server is a network server 120 shown in FIG. 1. The network server includes a receiving module 1010, a second judging module 1020, and a second login module 1030.

The receiving module 1010 is used for receiving an account waiting for login, a first password and a second password bound with the account sent by a terminal.

The second judging module 1020 is used for judging whether the first password is the same as at least one set of local passwords bound with the pre-stored account.

The second login module 1030 is used for matching the second password received with a login password corresponding to the account, and allowing the terminal to log in to the account once they are successfully matched, if the second judging module judges that the first password is the same as any set of the local passwords bound with the pre-stored account.

Preferably, the at least one set of the local passwords bound with the pre-stored account includes at least one custom password. The second judging module 1020 may be used for receiving the account waiting for login, the first password and the second password bound with the account sent by the terminal, and the second login module 1030 may be used for judging whether the first password is the same as the at least one custom password bound with the pre-stored account.

More preferably, the at least one set of the local passwords bound with the pre-stored account includes at least one combination of custom passwords and machine codes. The second judging module 1020 may be used for receiving the account waiting for login, an input password and a machine code of the terminal sent by the terminal, and combining the input password and the machine code of the terminal as the first password. The second login module 1030 may be used for judging whether the first password is the same as at least one combination of the custom password bound with the pre-stored account and the machine code.

To be sure, the network server is divided in line with the function modules illustrated in the above embodiment, though in practice the above functions can be assigned to different function modules, if necessary. That is, the inner structure of the network server can be divided into different function modules to complete some or all of the above functions. Besides, the network server in the above embodiment and the login method in Embodiment 5 belong to the same invention, and the concrete realization process is shown in the method embodiment and will not be listed hereon, repeatedly.

To sum up, with the network server provided in Embodiment 8 of the present invention, when an account and its first password are both correct, compare a second password and a login password in a network server, and allow the login if the second password is the same as the login password in the network server. Otherwise, it means that the login password has been changed by a legal user, and an illegal user cannot use the original first password and second password to log in to the corresponding account. Therefore, it makes the account login safer, and offers greater user experience.

It should be noted that, in the embodiments of the present invention, the data sent to the network server by the terminal, such as an account and a second password bound together, or an account, a local password and a second password bound together, or an account, a first password and a second password bound together, can be encrypted before transmission. As such, the safety of the data can be guaranteed in the transmission process.

It is understandable for those skilled in the art that, some or all steps shown in the embodiments of the present invention can be achieved by hardware, or by corresponding hardware with program instructions stored in a computer readable storage medium such as a read-only memory, a hard drive, or an optical disc, etc.

The above are only preferred embodiments of the present invention and not for limiting the invention. Any modification, equivalent replacement or improvement etc. on the invention without departing from the spirit and principle of the present invention are within the scope of the claims of the present invention.

1. A login method, comprising:
acquiring an account waiting for login and a first password;
judging whether the first password is the same as a local password bound with the pre-stored account; and
when the first password is the same as the local password bound with the pre-stored account, uploading a second password corresponding to the pre-stored account to a network server for matching, and logging in to the account when the second password is successfully matched.

2. The method according to claim 1, wherein the local password bound with the pre-stored account comprises: a custom password, or a combination of a custom password and a machine code.

3. The method according to claim 2, wherein acquiring the first password comprises:
receiving the first password input by a user; or
receiving a password input by a user, acquiring a machine code of a terminal, and combining the machine code with the input password as the first password; and
the process of judging whether the first password is the same as the local password bound with the pre-stored account comprises:
judging whether the first password is the same as the custom password bound with the pre-stored account; or
judging whether the first password is the same as the combination of the custom password bound with the pre-stored account and the machine code.

4. A login device, comprising:
an acquiring module, to acquire an account waiting for login and a first password;
a first judging module, to judge whether the first password is the same as a local password bound with the pre-stored account; and
a first login module, to upload a second password corresponding to the pre-stored account to a network server for matching, and log in to the account when the second password is successfully matched, when it is determined by the first judging module that the first password is the same as the local password bound with the pre-stored account.

5. The device according to claim 4, wherein the local password bound with the pre-stored account comprises: a custom password, or a combination of a custom password and a machine code.

6. The device according to claim 5, wherein the acquiring module is to receive the first password input by the user; or, the acquiring module is to receive an input password of the user, acquire a machine code of a terminal, and combine the input password with the machine code as the first password; and
the first judging module is to judge whether the first password is the same as the custom password bound with the pre-stored account; or, the first judging module is to judge whether the first password is the same as the combination of the custom password bound with the pre-stored account and the machine code.

7. A terminal, comprising: the login device as claimed in claim 4.

8. A login system, comprising:
the terminal according to claim 7; and
a network server;
wherein the network server comprises:
a receiving module, to receive an account waiting for login, a first password and a second password bound with the account sent by a terminal;
a second judging module, to judge whether the first password is the same as at least one set of local passwords bound with the pre-stored account; and
a second login module, to match the second password received with a login password corresponding to the account, and allow the terminal to log in to the account when the two passwords are successfully matched, when the second judging module judges that the first password is the same as any set of the local passwords bound with the pre-stored account.
